(19) United States
(12) Patent Application Publication
(10) Pub. No.: US 2024/0346448 A1
(43) Pub. Date: Oct. 17, 2024

(54) PROJECT INSPECTION SYSTEMS AND METHODS

(71) Applicant: MiView Integrated Solutions, LLC, MiView Integrated Solutions, LLC, TX (US)

(72) Inventor: Luis A. Uriarte, Frisco, TX (US)

(21) Appl. No.: 18/638,055

(22) Filed: Apr. 17, 2024

Related U.S. Application Data
(60) Provisional application No. 63/610,401, filed on Dec. 14, 2023.
(60) Provisional application No. 63/459,931, filed on Apr. 17, 2023.

(51) Int. Cl. G06Q 10/10; G06Q 10/1093

(52) U.S. Cl. CPC G06Q 10/103; G06Q 10/1097

(57) ABSTRACT

A project inspection system is used to coordinate multiple entities to work together to prepare a project for inspection. In an embodiment, a method includes: receiving a request for an inspection of a building; scheduling, at a first worker device, a first pre-inspection task for the building in response to receiving the request for the inspection of the building; receiving, from the first worker device, a confirmation that the first pre-inspection task was performed; notifying a manager device that the building is ready for the inspection in response to receiving the confirmation that the first pre-inspection task was performed; obtaining a result of the inspection of the building; and scheduling, at the first worker device, a follow-up task for the building, the follow-up task being automatically scheduled based on the result of the inspection of the building.

### CROSS-REFERENCE TO RELATED APPLICATIONS

This application claims the benefit of U.S. Provisional Application No. 63/459,931, filed on Apr. 17, 2023, and U.S. Provisional Application No. 63/610,401, filed on Dec. 14, 2023, which applications are hereby incorporated herein by reference.

### BACKGROUND

Project management systems are used to track and process data about projects and to coordinate teams working together on projects. A project management system may create, schedule, and track tasks and milestones for a project. Project management systems are particularly useful in fabrication, where multiple, interdisciplinary teams work together to create, assemble, or construct a building or a product. Examples of projects where a project management system may be used include building construction, vehicle manufacturing, and the like. Quality control is an important issue in such fabrication.

### BRIEF DESCRIPTION OF THE DRAWINGS

Aspects of this disclosure are best understood from the following detailed description when read with the accompanying figures.

FIG. 1 is a block diagram of a computing system, according to some embodiments.

FIG. 2 is a sequence diagram of a project inspection method, according to some embodiments.

FIGS. 3A-3C are sequence diagrams of inspection task redundancy methods, according to some embodiments.

FIG. 4 is a flow diagram of an inspection metric tracking method, according to some embodiments.

FIG. 5 is a sequence diagram of an inspection task reassignment method, according to some embodiments.

FIG. 6 is a diagram of a project inspection method, according to some embodiments.

Corresponding numerals and symbols in the different figures generally refer to corresponding parts unless otherwise indicated. The figures are drawn to clearly illustrate the relevant aspects of this disclosure and are not necessarily drawn to scale.

### DETAILED DESCRIPTION OF EMBODIMENTS

This disclosure provides many different examples for implementing different features. Specific examples of components and arrangements are described below to simplify this disclosure. These are, of course, merely examples and are not intended to be limiting.

According to various embodiments, a project inspection system is used to coordinate multiple entities to work together to prepare a project for inspection. Inspection tasks may be automatically scheduled responsive to a request for an inspection. The inspection tasks may be performed to prepare a project, thereby increasing the likelihood of the project passing inspection. Follow-up tasks may be automatically scheduled based on a result of the inspection. For example, the result of the inspection may be classified using a classification model including a neural network to automatically schedule follow-up tasks. The follow-up tasks may be more quickly scheduled and performed, decreasing the time for completing a project.

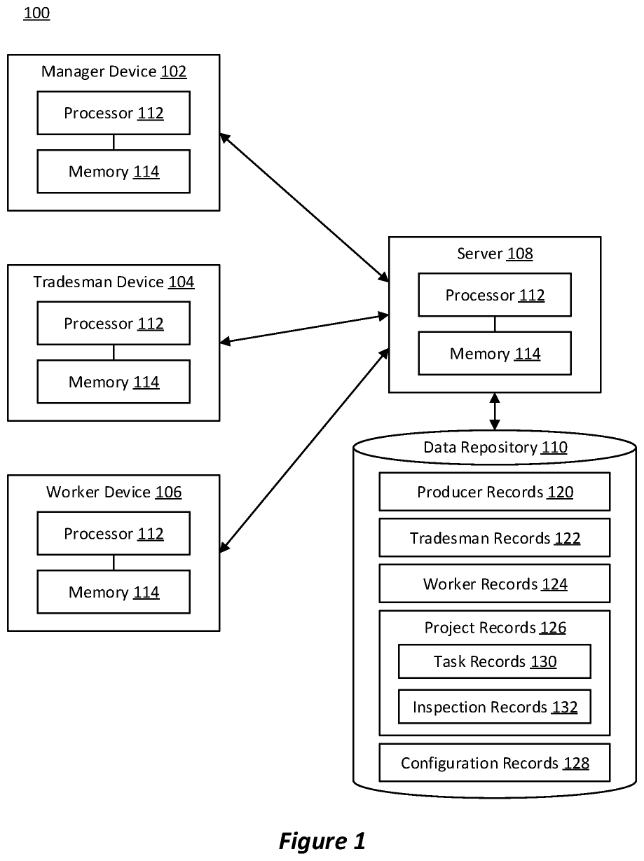

FIG. 1 is a block diagram of a computing system 100, according to some embodiments. The computing system 100 may be used to form or implement a project management system. Specifically, and as subsequently described in greater detail, the computing system 100 is part of a project inspection system for managing inspections of a project. The computing system 100 of this example is in a client-server environment that includes multiple devices 102-110, including one or more manager devices 102, one or more tradesman devices 104, one or more worker devices 106, a server 108, and a data repository 110.

The manager devices 102 may be used by managers of the project management system. A manager is a user of a producer for which a project is being performed. For example, when the project is construction of a building, the producer may be a builder, and a manager may be a user of the builder. Likewise, when the project is manufacturing of a product, the producer may be a manufacturer, and a manager may be a user of the manufacturer. Managers execute one or more applications on the manager devices 102 to access the project management system, view and manipulate schedules and project timelines, and the like. For example, a user of a builder may use a manager device 102 to plan housing communities and schedule contractors to build homes.

The tradesman devices 104 may be used by tradesmen of the project management system. A tradesman is part of a trade that performs task(s) for a producer of a project. For example, when the project is construction of a building, the producer may be a builder, and a tradesman may be a contractor (e.g., plumbing, electrical, HVAC, etc.) for the builder. Tradesmen execute one or more applications on the tradesman devices 104 to access the project management system, assign schedules and tasks to workers, and the like. For example, a contractor may use a tradesman device 104 to coordinate performing tasks for a builder of a building.

The worker devices 106 may be used by workers of the project management system. A worker is an individual who works for a tradesman. For example, when the project is construction of a building, a worker may be a crew member or a punchman of a contractor for the builder. Workers execute one or more applications on the worker devices 106 to view their schedules and assigned task list, complete tasks, and the like. For example, a plumbing crew member may use a worker device 106 to see which plumbing construction tasks are to be performed for a building on a given day.

The server 108 receives requests from the devices 102-106, processes the requests to update the data stored in the data repository 110, and responds to the devices 102-106 based on the data stored in the data repository 110. A request to the server 108 may be provided in a suitable message, such as a hypertext transfer protocol (HTTP) request, a system-specific command, or the like. Suitable messaging techniques may be used by the server 108 and the devices 102-106. One or more applications execute on the server 108 to process data and respond to requests. In a client-server environment, a device 102-106 performing an action may include the device 102-106 sending a request for the action to the server 108. For example, a tradesman device 104 may schedule a task for a worker by sending a task scheduling request to the server 108, which causes the server 108 to perform steps that accomplish the task scheduling (such as creating database records for the task and associating those records with the worker).

The data repository 110 may store data (or more generally, information) for the project management system. Examples of data for the project management system include data about projects, producers, tradesmen, workers, and the like. The data repository 110 may include a file system, database, data structure, or other suitable storage mechanism. For example, the data repository 110 may be implemented with a database, such as a relational database, a key-value store, or the like. The data for the project management system may include records stored in a database.

Although a single server 108 is illustrated and described herein, multiple servers 108 could be utilized in some embodiments. Specifically, multiple servers 108 may be utilized to handle requests in order to achieve redundancy, load balancing, and the like. Likewise, although a single data repository 110 is illustrated and described herein, multiple data repositories 110 could be utilized. Optionally, a load balancer (not separately illustrated) may be utilized to balance requests from the devices 102-106 across the servers 108 and/or the data repositories 110. A request may be sent to a server 108 by sending the request to the load balancer, which then selects and routes the request to an appropriate server 108.

The devices 102-108 may be any suitable devices. For example, the manager devices 102, the tradesman devices 104, and the worker devices 106 may each include one or more computers, mobile devices, laptop computers, tablet computers, or the like. Likewise, the server 108 and the data repository 110 each may include one or more computers, mainframes, blade servers, or the like.

Each device 102-108 of the computing system 100 includes various hardware components to achieve its desired functionality. The hardware components of a device may include a processor 112 and a memory 114. The hardware components of a device may be interconnected through a number of busses and/or network connections.

The processor 112 retrieves executable code from the memory 114 and executes the executable code. The executable code may, when executed by the processor 112, cause the processor 112 to implement any functionality described herein. The processor 112 may be a microprocessor, an application-specific integrated circuit, a microcontroller, or the like.

The memory 114 may include various types of memory, including volatile and nonvolatile memory. For example, the memory 114 may include Random-Access Memory (RAM), Read-Only Memory (ROM), a Hard Disk Drive (HDD), and/or the like. Different types of memory may be used for different data storage needs. For example, the processor 112 may boot from ROM, maintain nonvolatile storage in an HDD, execute program code stored in RAM, and store data under processing in RAM. The memory 114 may include a non-transitory computer readable medium that stores instructions for execution by the processor 112. One or more modules within the computing system 100 may be partially or wholly embodied as software and/or hardware for performing any functionality described herein.

The devices 102-110 may communicate via any suitable network (not separately illustrated). A network may include routers, switches, links, and the like. The components of the network work together to provide interconnection between the devices 102-110. The network may include a local area network (LAN), a wide area network (WAN), a mobile network, or any other type of network. Some components of the computing system 100, such as the server 108 and the data repository 110, may be part of a cloud computing system.

An inspection of a project may be performed to confirm quality control of the project, such as to confirm the project complies with regulations and the like. For example, when the project is construction of a building, an inspection of the building may be performed by a government to confirm the building complies with a building code. Project inspection may call for the coordination of multiple entities. For example, a manager may request (via a manager device 102) inspection of a building by a government and may then notify the relevant tradesman of the scheduled inspection. A tradesman may then dispatch (via a tradesman device 104) a worker to perform a task to prepare the building for inspection. For example, a plumbing contractor may dispatch a worker to confirm the building's plumbing is in compliance with a plumbing code before the scheduled inspection, thereby increasing the likelihood of the building passing inspection. The worker may perform work for the task and then confirm (via the worker device 106) that the task was performed. The tradesman and the manager may then be notified that the building has been prepared and is ready for inspection. Further, the tradesman or the manager may enter a result of the inspection after the inspection is complete. Within the computing system 100, the server 108 automatically coordinates the devices 102-106 so that the appropriate entities (e.g., managers, tradesmen, and workers) work together to confirm a project is prepared for inspection.

The data repository 110 stores records that are used for automatically coordinating inspections. For example, the data repository 110 may store producer records 120, tradesman records 122, worker records 124, project records 126, and configuration records 128. Each producer record 120 is associated with a producer (e.g., a builder); each tradesman record 122 is associated with a tradesman (e.g., contractor); each worker record 124 is associated with a worker (e.g., crew member/punchman of a contractor); and each project record 126 is associated with a project being performed for a producer (e.g., a builder).

The configuration records 128 may include configuration data for managers, configuration data for tradesmen, configuration data for workers, and/or configuration data for projects. A configuration record 128 may include data about a project for a producer. For example, when the project is a building for a builder, a configuration record 128 may include the location of the building, the community in which the building is being constructed, stage data for the building (indicating the stages of construction for the building), and the like. A configuration record 128 may also include inspection settings (subsequently described) for a project, manager, or tradesman. A configuration record 128 may include contact data for managers that wish to be updated about inspections. For example, when the project is a building, the contact data may include contact data for the construction manager, area manager, construction director, vice president, etc. of the builder. The contact data may be used to automatically notify relevant contacts (e.g., via email, push notifications, etc.) of the statuses/results of inspections. A configuration record 128 may also include settings for managers, tradesmen, and workers. For example, and as subsequently described in greater detail, a configuration record 128 may include inspection settings for tradesmen, such as settings specifying which inspection tasks should be performed, how inspection tasks should be scheduled for a tradesman's workers, how workers are assigned to inspection tasks, the amount of time that should be scheduled for inspection tasks, and the like.

Each project record 126 is associated with a project being performed for a producer. For example, when a project is a building being constructed by a builder, a project record 126 may be associated with the building. A project record 126 includes task records 130 and inspection records 132 for the project.

The task records 130 are associated with work items to be performed by a worker (e.g., crew member/punchman of a contractor). The task records 130 may include records for inspection tasks, such as pre-inspection tasks and follow-up tasks (e.g., re-inspection tasks and post-inspection tasks). A pre-inspection task is to be performed to prepare a project before an inspection. A re-inspection task is to be performed to prepare a project for re-inspection after failure of an inspection. A post-inspection task is to be performed to finalize a project after passing an inspection. For example, when the project is a building, a pre-inspection task may be a task to top off the building's plumbing before an inspection, and a post-inspection task may be a task to remove a test meter that was used for the inspection. A task record 130 may have a field that indicates the status of the task (e.g., “in progress,” “complete,” or “cancelled”).

As subsequently described in greater detail, the worker records 124 may be related and automatically assigned to the task records 130. For example, a worker (such as a punchman) may be associated with a community. The server 108 may periodically identify unassigned tasks for buildings in a community and then assign those task records 130 to the worker for the community (by associating those task records 130 with the appropriate worker records 124).

The inspection records 132 are associated with a project. The inspection records 132 may include records for inspection attempts, inspection results, and the like. An inspection attempt is a record with a field that indicates whether a project is ready and/or scheduled for inspection. An inspection result is a record with a field that indicates whether a project passed inspection. For example, when the project is a building, an inspection attempt may initially be set to “not scheduled” before the building is scheduled or ready for inspection, may be set to “scheduled” when the building is scheduled but not ready for inspection, and may be set to “ready for inspection” when the building is both scheduled and ready for inspection. Likewise, when the project is a building, an inspection result may be set to “green tag” when the building passes inspection and may be set to “red tag” when the building fails inspection. Other suitable values could be used for the fields of the inspection records 132.

Users of the devices 102-106 may have different views of the data in the data repository 110. Suitable authentication and authorization techniques may be used to limit access of the data in the data repository 110 to appropriate users. For example, a manager (using a manager device 102) may be authorized to view the data of one or more tradesmen and/or may be authorized to view some (but not necessarily all) data of those tradesmen's workers. A tradesman (using a tradesman device 104) may be authorized to view some (but not necessarily all) data of their manager and some (but not necessarily all) data of other tradesmen. A worker (using a worker device 106) may be authorized to view some (but not necessarily all) data of their tradesman and some (but not necessarily all) data of other workers for their tradesmen.

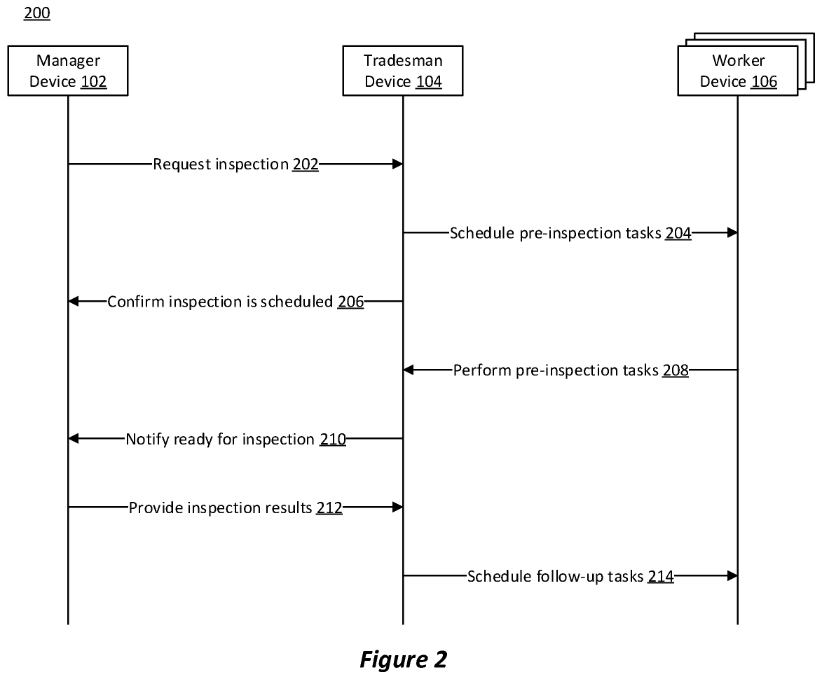

FIG. 2 is a sequence diagram of a project inspection method 200, according to some embodiments. FIG. 2 will be described in conjunction with FIG. 1. The project inspection method 200 may be performed within the computing system 100 to coordinate an inspection of a project. For example, the project inspection method 200 may be performed to coordinate inspection of a building.

Initially, the server 108 may create or update an appropriate inspection record 132 and appropriate task records 130 in the data repository 110. For example, a manager may set the project record 126 of a project (e.g., building) to be in a particular stage of construction and may assign a start date to that stage of construction. Upon assigning the stage of construction and scheduling its start date, an inspection record 132 may be created and assigned to the project record 126 for the project. The inspection record 132 may be an inspection attempt that the server 108 sets to “not scheduled.” Likewise, the task records 130 may be created and assigned to the project record 126 for the project.

In step 202, the manager (operating a manager device 102) sends a request for an inspection of a project to a tradesman (operating a tradesman device 104). As previously noted, a manager may be a user of a builder, while a tradesman may be a contractor for the builder. The inspection may be an inspection of work performed by the contractor, such as work performed by a crew member of the contractor. The request for the inspection may indicate the previously-created inspection record 132 for the project (e.g., building) as well as a date on which the inspection is requested.

The manager may send the request for the inspection to the tradesman by using the manager device 102 to send an inspection request message (which includes the request for the inspection) to the server 108, which may process the inspection request message as appropriate, such as by updating the appropriate inspection record 132. The result of processing the inspection request message may be sent or displayed to the tradesman using the tradesman device 104.

In step 204, the tradesman (operating the tradesman device 104) schedules one or more pre-inspection tasks for the requested inspection with one or more workers (operating worker devices 106). The pre-inspection tasks that are scheduled are those tasks which should be performed to prepare the project for inspection. For example, when the project is a building, the pre-inspection tasks may be tasks to confirm the building complies with a building code before inspection by a government. As a more specific example, when the tradesman is a plumbing contractor, the pre-inspection tasks may be tasks for a crew member or punchman of the plumbing contractor to confirm the building complies with a plumbing code. Scheduling a pre-inspection task includes assigning the pre-inspection task to a worker and setting a due date (based at least in part on the inspection request) by which the worker is requested to perform the pre-inspection task.

The tradesman may schedule the pre-inspection tasks with the workers by using the tradesman device 104 to send a task scheduling message to the server 108, which may process the task scheduling message as appropriate, such as by updating the appropriate task records 130. For example, a task record 130 may be updated so that it is associated with the appropriate worker record 124 and has a due date field set to the desired value. The pre-inspection tasks may be automatically scheduled based on the configuration and stage of the project (as indicated by the configuration record 128 for the project), the configuration of the tradesman (as indicated by the configuration record 128 for the tradesman), or any other suitable configuration. For example, the due dates for the pre-inspection tasks may be automatically generated based on a combination of the configuration record 128 and the inspection request. Likewise, which pre-inspection tasks are scheduled may be automatically determined based on any of the aforementioned configuration records 128. The result of processing the task scheduling message may be sent or displayed to the workers using the worker devices 106.

In some embodiments, multiple pre-inspection tasks are scheduled with multiple workers. As subsequently described in greater detail, redundant tasks may be utilized, such that multiple (redundant) pre-inspection tasks are scheduled for multiple (redundant) workers. In some embodiments, a single pre-inspection task is scheduled with a single worker. Whether single or multiple pre-inspection tasks are used may be determined by the configuration record 128 for the project, the configuration record 128 for the tradesman, or another suitable configuration record 128. Continuing the example where the tradesman is a plumbing contractor, the configuration record 128 for the plumbing contractor may indicate whether a crew member of the plumbing contractor should perform an inspection preparation task, whether a punchman of the plumbing contractor should perform a top off task, or whether both should be performed. If a configuration record 128 indicates that both are to be performed, then both are scheduled. Additionally or alternatively, the configuration record 128 for the building may indicate which crew member(s) of the plumbing contractor should perform the tasks.

A requesting entity (e.g., tradesman or manager) may also request inspection of the project (e.g., building) by the inspector (e.g., government) on the inspection date requested by the manager (in step 202). The requesting entity may automatically send the request to the inspector by calling a suitable application programming interface (API) of an inspector management platform for the inspector, such as eTRAKiT. Alternatively, the requesting entity may send the request to the inspector by phone, email, or the like. The inspection request sent to the inspector may be different than the inspection request sent to the tradesman (in step 202).

In step 206, the tradesman (operating the tradesman device 104) optionally confirms to the manager (operating the manager device 102) that the inspection has been scheduled. That is, the tradesman sends a confirmation of the inspection of the project to the manager. The confirmation may be sent after the pre-inspection tasks have been scheduled with the appropriate workers, and the inspection has been requested from the inspector.

The tradesman may send the confirmation of the inspection to the manager by using the tradesman device 104 to send an inspection confirmation message (which includes the confirmation of the inspection) to the server 108, which may process the inspection confirmation message as appropriate, such as by updating the appropriate inspection record 132. The inspection record 132 may be an inspection attempt that the server 108 sets to “scheduled.” The result of processing the inspection confirmation message may be sent or displayed to the manager using the manager device 102.

As previously noted, the configuration record 128 for a project may include contact data for multiple managers. The confirmation of the inspection may be sent to one or more of those managers, as specified by the configuration record 128. The confirmation of the inspection may, based on the configuration record 128, be sent manually (by the tradesman) or scheduled for automatic delivery by the server 108. Additionally, confirmations of inspections may be delayed and batched, so that a single communication with the managers may include multiple confirmations of inspections for multiple projects.

In step 208, the workers (operating worker devices 106) perform their pre-inspection tasks and notify the tradesman (operating the tradesman device 104). A worker performs a pre-inspection task assigned to them by performing the work (e.g., at a project worksite) specified by the pre-inspection task, and then notifying the tradesman that the work is complete. For example, a worker may mark a pre-inspection task as complete via their worker device 106.

A worker may send a confirmation to the tradesman that their pre-inspection task is complete by using a worker device 106 to send a task completion message (which includes the confirmation that the pre-inspection task is complete) to the server 108, which may process the task completion message as appropriate, such as by updating the appropriate task record 130. The result of processing the task completion message may be sent or displayed to the tradesman using the tradesman device 104.

Furthermore, the server 108 may update the appropriate inspection record 132 when the project is considered ready for inspection. The inspection record 132 may be an inspection attempt that the server 108 sets to “ready for inspection.” A configuration record 128 (such as one for the project, the tradesmen, or the like) may specify the criteria for when the inspection attempt is to be set to “ready for inspection.” In some embodiments, the project is considered ready for inspection when all the scheduled pre-inspection tasks have been performed. In some embodiments, the project is considered ready for inspection when a subset of the scheduled pre-inspection tasks have been performed.

In step 210, the tradesman (operating the tradesman device 104) optionally notifies the manager (operating the manager device 102) that the project is ready for inspection. That is, the tradesman sends a notification of inspection readiness to the manager, notifying them that the pre-inspection tasks have been completed by the appropriate workers.

The tradesman may send the notification of the inspection to the manager by using the tradesman device 104 to send a readiness notification message (which includes the notification of the inspection readiness) to the server 108, which may process the readiness notification message as appropriate. The result of processing the readiness notification message may be sent or displayed to the manager using the manager device 102.

As previously noted, the configuration record 128 for a project may include contact data for multiple managers. The notification of the inspection readiness may be sent to one or more of those managers, as specified by the configuration record 128. The notification of the inspection readiness may, based on the configuration record 128, be sent manually (by the tradesman) or scheduled for automatic delivery by the server 108. Additionally, notifications of inspection readiness may be delayed and batched, so that a single communication with the managers may include multiple notifications of inspection readiness for multiple projects.

In step 212, the manager (operating the manager device 102) provides a result of the inspection to the tradesman (operating the tradesman device 104). The result of the inspection is obtained from the inspector (e.g., government) and indicates whether the project passed or failed inspection. The manager may automatically obtain the result from the inspector by calling a suitable application programming interface (API) of an inspector management platform for the inspector, such as eTRAKIT. Alternatively, the manager may obtain the result directly from the inspector (e.g., by physical handoff at a project worksite), or may obtain the result from the inspector by phone, email, or the like.

The manager may provide the result of the inspection by using the manager device 102 to send an inspection result message (which includes the result of the inspection) to the server 108, which may process the inspection result message as appropriate, such as by updating the appropriate inspection record 132. The inspection record 132 may be an inspection result that the server 108 sets to “green tag” if the project passed inspection or to “red tag” if the project failed inspection. The result of processing the inspection result message may be sent or displayed to the tradesman using the tradesman device 104.

In this embodiment, the manager provides the result of the inspection. In another embodiment, a tradesman provides the result of the inspection. For example, a tradesman may obtain the result from the inspector using any of the aforementioned techniques. The tradesman may provide the result of the inspection by using the tradesman device 104.

If the result of the inspection indicates the project failed inspection, then fault for the failure may be automatically assigned to a tradesman. For example, the result of the inspection (from the inspector) may include details (e.g., an image and/or a description) about why the project failed inspection. The details may be used to identify the tradesman who performed the work which caused the project to fail inspection, such as with a classification model (subsequently described). Fault may be assigned to that tradesman, such as by updating the appropriate inspection record 132. The inspection record 132 may be an inspection result that is updated to include support (e.g., the details from the result of the inspection) for why a tradesman was at fault for a failed inspection.

In some situations, the result of the inspection is not received within 24 hours from the scheduled inspection. The appropriate inspection record 132 may be updated in that case. The inspection record 132 may be an inspection result that the server 108 sets to “pending results” while awaiting the result of the inspection.

In step 214, the tradesman (operating the tradesman device 104) schedules one or more follow-up tasks with one or more workers (operating worker devices 106). The scheduling of the follow-up tasks may be initiated when the result of the inspection is provided (in step 212). The follow-up tasks may be post-inspection tasks or re-inspection tasks. To schedule a follow-up task, the server 108 may update an appropriate task record 130 for the desired type of follow-up task.

The follow-up tasks may be automatically scheduled by the server 108 based on the result of the inspection (obtained in step 212) as well as one or more configuration records 128. As previously noted, the inspection result (from the inspector) may include details (e.g., an image and/or a description). The details may indicate whether a project passed/failed inspection and (if applicable) why the project failed inspection. The inspection result may be classified using a classification model including a neural network. In some embodiments, the image of the result is classified using a neural network that is trained to automatically classify the image of the result. In some embodiments, the description of the result is classified using a neural network that is trained to automatically classify the description of the result. The classification model may have been previously trained using a machine learning process with a set of training inspection results. The follow-up tasks are then scheduled based on the classification of the inspection result (as determined by the classification model). Specifically, if the classification of the inspection result is a passed inspection, then post-inspection tasks are scheduled, but if the classification of the inspection result is a failed inspection, then re-inspection tasks are scheduled.

A post-inspection task is performed to finalize work for a project after it passes an inspection. Thus, the post-inspection tasks may be automatically scheduled by the server 108 in response to the result of the inspection indicating the project passed inspection (e.g., the inspection record 132 being set to “green tag”). The post-inspection tasks may be scheduled with the appropriate workers, which may (or may not) be different than the workers who performed the pre-inspection tasks. For example, when the project is a building, a post-inspection task may be a task to remove a test meter that was used for the inspection, and that post-inspection task may be automatically assigned to a crew who removes test meters. Which post-inspection tasks are scheduled may be determined based on the configuration record 128 for the project, the configuration record 128 for the tradesman, or another suitable configuration record 128. To schedule a post-inspection task, the server 108 may update an appropriate task record 130 for the post-inspection task. For example, a task record 130 may be updated so that it is associated with the appropriate worker record 124 and has a due date field set to the desired value.

A re-inspection task is performed to prepare a project for re-inspection after it fails an inspection. Thus, the re-inspection tasks may be automatically scheduled by the server 108 in response to the result of the inspection indicating the project failed inspection (e.g., the inspection record 132 being set to “red tag”). The re-inspection tasks may be scheduled with the appropriate workers, which may (or may not) be different than the workers who performed the pre-inspection tasks. For example, a re-inspection task may (or may not) be similar to the preceding pre-inspection task. Which re-inspection tasks are scheduled may be determined based on the configuration record 128 for the project, the configuration record 128 for the tradesman, or another suitable configuration record 128. To schedule a re-inspection task, the server 108 may update an appropriate task record 130 for the re-inspection task. For example, a task record 130 may be updated so that it is associated with the appropriate worker record 124 and has a due date field set to the desired value. In some embodiments, the re-inspection tasks are the same as the pre-inspection tasks (scheduled in step 204) but are scheduled for different days. For example, the pre-inspection tasks may be rescheduled and assigned to be completed within one day of the failure of the inspection.

A re-inspection task may be scheduled based on the reasons for failure in the inspection result. For example, an inspection result may include an issue that caused the building to fail inspection, and the re-inspection task may include instructions to perform work (at the project worksite) to fix that issue with the building.

The follow-up tasks may follow a similar process as previously described. For example, if the follow-up tasks include re-inspection tasks, then steps 204-212 may be repeated as appropriate. Likewise, if the follow-up tasks include post-inspection tasks, then the project inspection method 200 may conclude upon completion of those post-inspection tasks.

For simplicity of discussion, FIG. 2 is described with respect to a single tradesman performing tasks to prepare a project for inspection. Multiple tradesmen may be coordinated by a manager to prepare a project for inspection. Some of the aforementioned steps may be performed by each of the tradesmen. In step 202, the manager may send a request for an inspection of a project to multiple tradesmen. In step 204, each of the tradesmen may schedule one or more pre-inspection tasks with their respective workers. The pre-inspection tasks for each tradesman may be scheduled based on the configuration record 128 for the respective tradesman, the configuration record 128 for the project, or another suitable configuration record 128. In step 206, each of the tradesmen may confirm to the manager that the inspection has been scheduled. In step 208, the workers of each tradesman perform their pre-inspection tasks and notify their respective tradesman. In step 210, each of the tradesmen optionally notify the manager that their portion of the project is ready for inspection. In step 212, one or more of the tradesmen receive a result of the inspection. Using any of the aforementioned techniques, the result of the inspection may be sent to each of the tradesmen, or (if the result is a failure) the result may only be sent to the tradesmen who were at fault for the failed inspection. In step 214, each of the tradesmen schedule one or more follow-up tasks with their workers. The follow-up tasks for each tradesman may be scheduled based on the configuration record 128 for the respective tradesman, the configuration record 128 for the project, or another suitable configuration record 128.

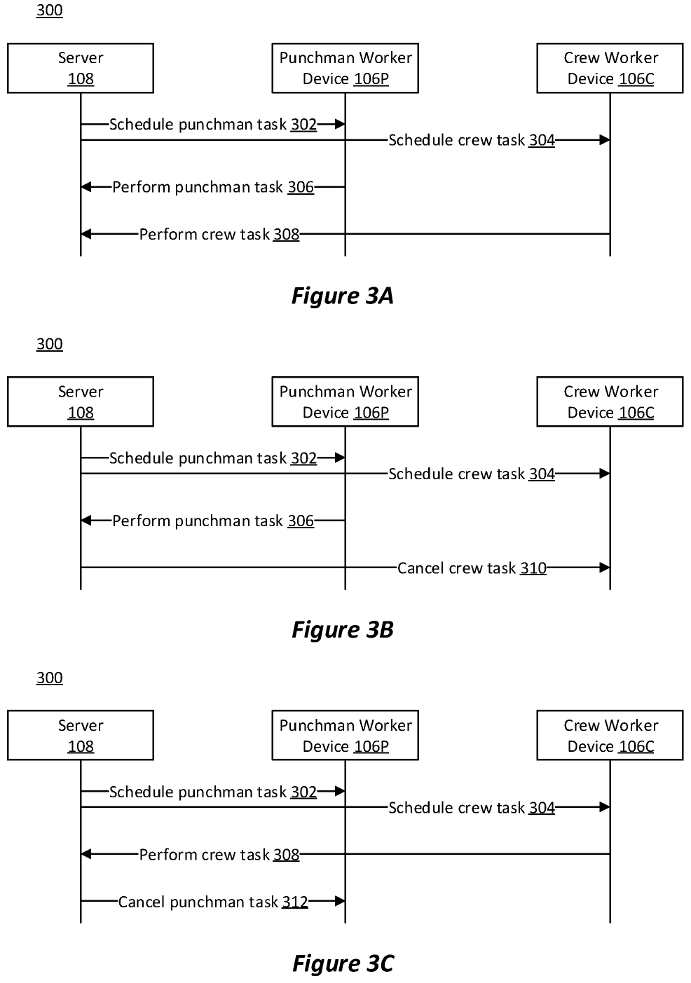

FIG. 3A is a sequence diagram of an inspection task redundancy method 300, according to some embodiments. FIG. 3A will be described in conjunction with FIG. 1. The inspection task redundancy method 300 may be performed within the computing system 100 during the scheduling/completion of redundant inspection tasks. The inspection task redundancy method 300 is described with reference to pre-inspection tasks, although it could be utilized for post-inspection tasks or re-inspection tasks.

In this example where the tradesman is a contractor, redundant pre-inspection tasks may be scheduled for a punchman and a crew member of the contractor. Furthermore, the project is considered ready for inspection when all the scheduled inspection tasks have been performed. Scheduling redundant pre-inspection tasks with different workers may further increase the likelihood of the project passing inspection, as there is a lower risk of the pre-inspection tasks being neglected.

In step 302, a punchman inspection task is scheduled for the punchman of the contractor (operating a punchman worker device 106P). The server 108 may do so by updating the appropriate task record 130.

In step 304, a crew inspection task is scheduled for the crew member of the contractor (operating a crew worker device 106C). The server 108 may do so by updating the appropriate task record 130.

The work called for by the punchman and crew inspection tasks may be different and may be specified by the configuration record 128 for the project, the configuration record 128 for the tradesman, or another suitable configuration record 128. The punchman inspection task (e.g., top off task) may be scheduled for a punchman of the plumbing contractor, such as a punchman assigned to the building or a punchman assigned to the community for the building. The crew inspection task (e.g., inspection preparation task) may be scheduled for the crew member who originally performed the work which is to be inspected (e.g., a member of a top out crew).

The punchman and crew inspection tasks may (or may not) be scheduled for different days. For example, the punchman inspection task may be scheduled for the requested date of the inspection, while the crew inspection task may be scheduled for one day before the requested date of the inspection. The offset (of days before the requested date of the inspection) for each inspection task may be configurable and specified by the configuration record 128 for the project, the configuration record 128 for the tradesman, or another suitable configuration record 128.

In step 306, the punchman (operating the punchman worker device 106P) performs the punchman inspection task. The punchman performs the punchman inspection task by performing the work (e.g., at a project worksite) specified by the punchman inspection task, and then notifying the server 108 that the work is complete.

In step 308, the crew member (operating the crew worker device 106C) performs the crew inspection task. The crew member performs the crew inspection task by performing the work (e.g., at a project worksite) specified by the crew inspection task, and then notifying the server 108 that the work is complete.

The server 108 may update the appropriate inspection record 132 when the project is ready for inspection. The inspection record 132 may be an inspection attempt. In this embodiment, the project is considered ready for inspection when all the scheduled inspection tasks have been performed. Thus, the inspection attempt may be set to “ready for inspection” when both the punchman inspection task (e.g., top off task) and the crew inspection task (e.g., inspection preparation task) are completed.

FIG. 3B is a sequence diagram of an inspection task redundancy method 300, according to some embodiments. This embodiment is similar to the embodiment of FIG. 3A, except the project is considered ready for inspection when a subset of the scheduled inspection tasks have been performed.

Steps 302-304 are performed as previously described for FIG. 3A. That is, the punchman and crew inspection tasks are both scheduled. Step 306 is then performed as previously described for FIG. 3A. That is, the punchman performs the punchman inspection task. In step 310, the crew inspection task is cancelled. The server 108 may update the appropriate task record 130 when cancelling an inspection task. Additionally, the crew member (operating the crew worker device 106C) may be notified by the server 108 that their crew inspection task was cancelled. At this point, the inspection attempt may be set to “ready for inspection” as one of the punchman inspection task (e.g., top off task) or the crew inspection task (e.g., inspection preparation task) are completed.

FIG. 3C is a sequence diagram of an inspection task redundancy method 300, according to some embodiments. This embodiment is similar to the embodiment of FIG. 3A, except the project is considered ready for inspection when a subset of the scheduled inspection tasks have been performed.

Steps 302-304 are performed as previously described for FIG. 3A. That is, the punchman and crew inspection tasks are both scheduled. Step 308 is then performed as previously described for FIG. 3A. That is, the crew member performs the crew inspection task. In step 312, the punchman inspection task is cancelled. The server 108 may update the appropriate task record 130 when cancelling an inspection task. Additionally, the punchman (operating the punchman worker device 106P) may be notified by the server 108. At this point, the inspection attempt may be set to “ready for inspection” as one of the punchman inspection task (e.g., top off task) or the crew inspection task (e.g., inspection preparation task) are completed.

Which inspection task redundancy method 300 (of FIG. 3A, 3B, or 3C) is utilized by a tradesman may be determined based on a suitable configuration record 128. In some embodiments, the configuration record 128 for the project may specify the desired inspection task redundancy method 300. In some embodiments, the configuration record 128 for the tradesman may specify the desired inspection task redundancy method 300.

Some variations are contemplated. Multiple crew inspection tasks may be scheduled for multiple crew members, while a single punchman inspection task may be scheduled for a single punchman. Continuing the example where the tradesman is a plumbing contractor, the scheduled inspection tasks may include a punchman inspection task (e.g., top off task), a first crew inspection task (e.g., inspection preparation task), and a second crew inspection task (e.g., gas inspection preparation task). The crew inspection tasks may be scheduled for the crew members who originally performed the work which is to be inspected (e.g., a member of a top out crew and a member of a top out gas crew). In some embodiments, the project may be considered ready for inspection when the punchman inspection task is complete; in that case, both the first and second crew inspection tasks may be cancelled. In some embodiments, the project may be considered ready for inspection when both the first and second crew inspection tasks are complete; in that case, the punchman inspection task may be cancelled. The criteria for the project being considered ready for inspection may be specified by the configuration record 128 for the tradesman, the configuration record 128 for the project, or another suitable configuration record 128.

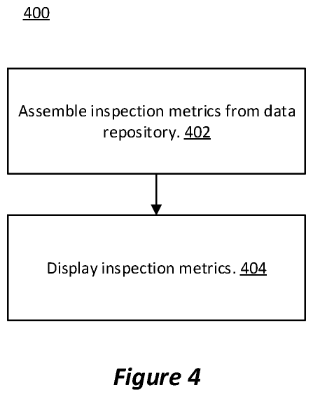

FIG. 4 is a flow diagram of an inspection metric tracking method 400, according to some embodiments. FIG. 4 will be described in conjunction with FIG. 1. Inspection metrics may be tracked in the computing system 100. The inspection metrics may be used by a builder or tradesman to analyze their performance at passing/failing inspections.

In step 402, inspection metrics are assembled. The inspection metrics may be assembled by selecting and analyzing inspection records 132 from the data repository 110. Multiple types of inspection metrics may be used. Fault rate of a tradesman is a metric that may be tracked. Other metrics may be tracked. For example, the pass rate of a tradesman, the quantity of inspections per day for a tradesman, the quantity of rescheduled inspections per day for a tradesman, the quantity of cancelled inspections per day for a tradesman, and the like may also be tracked. Additionally, sometimes a no-notice inspection may be performed by an inspector. The quantity of no-notice inspections for a tradesman may also be tracked.

In step 404, the inspection metrics are displayed, such as with a manager device 102 or with a tradesman device 104. The inspection metrics may be graphed and compared against one another. For example, a manager may compare the pass/fail rates of multiple tradesmen, to determine which tradesmen are more efficiently passing inspection.

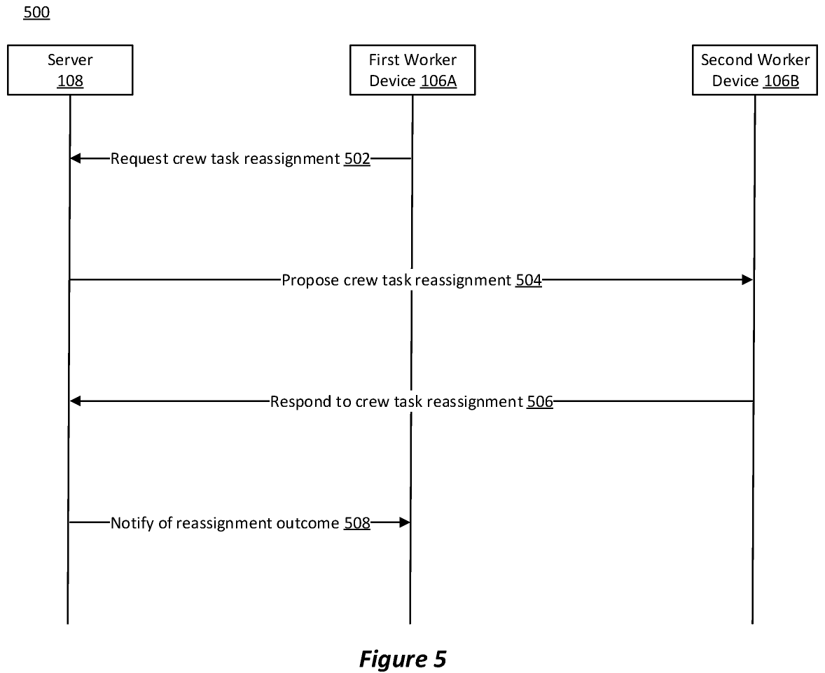

FIG. 5 is a sequence diagram of an inspection task reassignment method, according to some embodiments. FIG. 5 will be described in conjunction with FIG. 1. The inspection tasks that are assigned to workers (operating worker devices 106) may be reassigned among the workers. For example, crew members may reassign inspection tasks to each other. Reassigning inspection tasks allows a crew member who is not able to perform an inspection task in time (before a scheduled inspection) to request reassignment of the inspection task to another crew member who is able to perform the inspection task in time.

In step 502, a first crew member (operating a first worker device 106A) requests reassignment of an inspection task that has been scheduled for the first crew member. Whether the first crew member is permitted to reassign an inspection task may be determined based on the configuration record 128 for the tradesman, the configuration records 128 for the crew members, or another suitable configuration record 128. The first crew member may select, on the first worker device 106A, the inspection task for which reassignment is desired. The first worker device 106A may fetch (from the server 108) a list of crew members to whom the inspection task could be reassigned. The list of crew members to whom the inspection task could be reassigned may be determined based on the configuration record 128 for the tradesman, the configuration records 128 for the crew members, or another suitable configuration record 128. For example, the first crew member may be permitted to reassign the inspection task to only a subset of the other crew members. The list may be presented to the first crew member, who may select a second crew member from the list. The first worker device 106A sends a reassignment message (which indicates the second crew member) to the server 108. The first crew member is notified (via the first worker device 106A) that the inspection task is awaiting reassignment.

In some embodiments, the inspection task is associated with a project (e.g., building) and the location of the project is known to the server 108 (such as stored in a project record 126). The crew members to whom the inspection task could be reassigned are those crew members in the same city/location as the project for the inspection task. Crew members who are closer to the location of the inspection task may be prioritized higher in the list presented to the first crew member.

In step 504, a reassignment proposal for the inspection task is sent to the second crew member (operating a second worker device 106B). The reassignment proposal is displayed on the second worker device 106B and asks the second crew member to accept or reject the proposed reassignment of the inspection task. The second worker device 106B sends a response message to the server 108 informing the server of whether the second crew member accepts or rejects the inspection task.

If the second crew member fails to respond to the reassignment proposal within a configurable time frame (e.g., 15 minutes), then the reassignment proposal may be considered by the server 108 to be rejected. The first worker device 106A may be notified of the rejection/timeout. The first crew member may again attempt to reassign the inspection task, at which point steps 502-504 may be repeated.

In step 506, a reassignment response for the inspection task is sent to the server 108 by the second crew member. The second worker device 106B sends a response message to the server 108, which includes the reassignment response of the second crew member. The server 108 may process the response message as appropriate, such as by updating the appropriate task record 130. If the reassignment response is an acceptance of the reassignment, the second crew member will now see the reassigned inspection task in their task list, while the first crew member will no longer see the reassigned inspection task in their task list. If the reassignment response is a rejection of the reassignment, the task record 130 may not be updated.

In step 508, the first crew member is notified of the outcome of the reassignment response. The server 108 may send a message to the first worker device 106A notifying the first worker device 106A whether the second worker device 106B accepted or rejected reassignment of the inspection task. If the task reassignment was rejected, the first crew member may again attempt to reassign the inspection task, at which point steps 502-506 may be repeated.

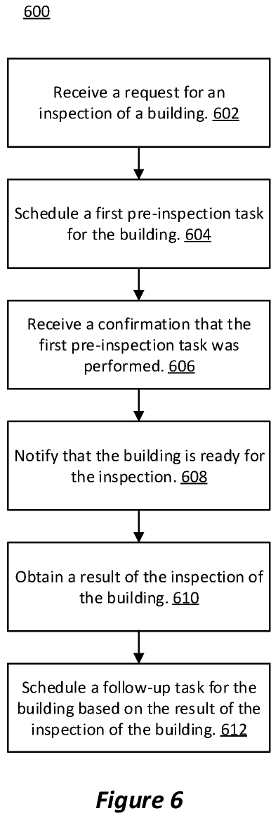

FIG. 6 is a diagram of a project inspection method 600, according to some embodiments. FIG. 6 will be described in conjunction with FIG. 1. The project inspection method 600 may be a computer-implemented method that is performed by the server 108, responsive to requests from the tradesman device 104. The project inspection method 600 is described with respect to a building but could be utilized for another type of project.

The server 108 performs a step 602 of receiving a request for an inspection of a building. The request for the inspection of the building may be received from a manager device 102.

The server 108 performs a step 604 of scheduling, at a first worker device 106, a first pre-inspection task for the building in response to receiving the request for the inspection of the building. The server 108 may also perform a step of scheduling, at a second worker device 106, a second pre-inspection task for the building in response to receiving the request for the inspection of the building. The first worker device 106 may be a punchman worker device 106P while the second worker device 106 may be a crew worker device 106C.

The server 108 performs a step 606 of receiving, from the first worker device 106, a confirmation that the first pre-inspection task was performed. The server 108 may also perform a step of cancelling the second pre-inspection task in response to receiving the confirmation that the first pre-inspection task was performed. The server 108 may also perform a step of receiving, from the second worker device 106, a confirmation that the second pre-inspection task was performed.

The server 108 performs a step 608 of notifying a manager device 102 that the building is ready for the inspection in response to receiving the confirmation that the first pre-inspection task was performed. The manager device 102 may be notified that the building is ready for the inspection further in response to receiving the confirmation that the second pre-inspection task was performed.

The server 108 performs a step 610 of obtaining a result of the inspection of the building. The result of the inspection of the building may be received from the manager device 102.

The server 108 performs a step 612 of scheduling, at the first worker device 106, a follow-up task for the building, the follow-up task being automatically scheduled based on the result of the inspection of the building. The result of the inspection of the building may be a failure, and the follow-up task for the building may be a re-inspection task for the building. The result of the inspection of the building may be a pass, and the follow-up task for the building may be a post-inspection task for the building.

Scheduling the follow-up task for the building may comprise: determining a classification of the result of the inspection using a classification model comprising a neural network; and creating the follow-up task based on the classification of the result of the inspection. Determining the classification of the result of the inspection may comprise classifying an image of the result of the inspection using the classification model, the neural network being trained to automatically classify the image of the result. Determining the classification of the result of the inspection may comprise classifying a description of the result of the inspection using the classification model, the neural network being trained to automatically classify the description of the result.

The server 108 may also perform a step of receiving, from the first worker device, a request to reassign the first pre-inspection task to a second worker device. The server 108 may also perform a step of sending, to the second worker device, the request to reassign the first pre-inspection task.

The server 108 may also perform a step of requesting inspection of the building from an inspector by calling an application programming interface (API) of an inspector management platform. The result of the inspection may be obtained by calling an application programming interface (API) of an inspector management platform.

When the result of the inspection of the building is a failure, the server 108 may also perform a step of assigning fault for the failure of the inspection based on details of the result of the inspection. The fault may be determined by classifying the details of the result of the inspection using a classification model, the classification model comprising a neural network trained to automatically classify the details of the result. Further, the server 108 may also perform a step of updating inspection metrics based on the result of the inspection.

Embodiments may include other aspects. For example, a user interface may be presented to a user device (e.g., the devices 102-106) from the server 108. An example of a user interface is illustrated and described with respect to FIG. 1 of U.S. Provisional Application No. 63/459,931. Additional examples and descriptions of embodiments of apparatuses, systems, and methods of inspection interfaces are illustrated and described with respect to Exhibit A of U.S. Provisional Application No. 63/459,931, and Exhibit A of U.S. Provisional Application No. 63/610,401.

While this disclosure describes and refers to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A computer-implemented method comprising:
receiving a request for an inspection of a building;
scheduling, at a first worker device, a first pre-inspection task for the building in response to receiving the request for the inspection of the building;
receiving, from the first worker device, a confirmation that the first pre-inspection task was performed;
notifying a manager device that the building is ready for the inspection in response to receiving the confirmation that the first pre-inspection task was performed;
obtaining a result of the inspection of the building; and
scheduling, at the first worker device, a follow-up task for the building, the follow-up task being automatically scheduled based on the result of the inspection of the building.

2. The computer-implemented method of claim 1, wherein scheduling the follow-up task for the building comprises:
determining a classification of the result of the inspection using a classification model comprising a neural network; and
creating the follow-up task based on the classification of the result of the inspection.

3. The computer-implemented method of claim 2, wherein determining the classification of the result of the inspection comprises classifying an image of the result of the inspection using the classification model, the neural network being trained to automatically classify the image of the result.

4. The computer-implemented method of claim 2, wherein determining the classification of the result of the inspection comprises classifying a description of the result of the inspection using the classification model, the neural network being trained to automatically classify the description of the result.

5. The computer-implemented method of claim 1, further comprising:
scheduling, at a second worker device, a second pre-inspection task for the building in response to receiving the request for the inspection of the building; and
receiving, from the second worker device, a confirmation that the second pre-inspection task was performed, wherein the manager device is notified that the building is ready for the inspection further in response to receiving the confirmation that the second pre-inspection task was performed.

6. The computer-implemented method of claim 1, further comprising:
scheduling, at a second worker device, a second pre-inspection task for the building in response to receiving the request for the inspection of the building; and
cancelling the second pre-inspection task in response to receiving the confirmation that the first pre-inspection task was performed.

7. The computer-implemented method of claim 6, wherein the first worker device is a punchman worker device and the second worker device is a crew worker device.

8. The computer-implemented method of claim 1, wherein the result of the inspection of the building is a failure, and the follow-up task for the building is a re-inspection task for the building.

9. The computer-implemented method of claim 1, wherein the result of the inspection of the building is a pass, and the follow-up task for the building is a post-inspection task for the building.

10. The computer-implemented method of claim 1, wherein the request for the inspection of the building is received from the manager device, and the result of the inspection of the building is received from the manager device.

11. The computer-implemented method of claim 1, further comprising:
receiving, from the first worker device, a request to reassign the first pre-inspection task to a second worker device; and
sending, to the second worker device, the request to reassign the first pre-inspection task.

12. The computer-implemented method of claim 1, further comprising:
requesting inspection of the building from an inspector by calling an application programming interface (API) of an inspector management platform.

13. The computer-implemented method of claim 1, wherein the result of the inspection is obtained by calling an application programming interface (API) of an inspector management platform.

14. The computer-implemented method of claim 1, wherein the result of the inspection of the building is a failure, and the computer-implemented method further comprises:
assigning fault for the failure of the inspection based on details of the result of the inspection.

15. The computer-implemented method of claim 1, further comprising:
updating inspection metrics based on the result of the inspection.

16. A system comprising:
a first worker device; and
a tradesman device configured to:
receive a request for an inspection of a building;
schedule, at the first worker device, a first pre-inspection task for the building in response to receiving the request for the inspection of the building;
receive, from the first worker device, a confirmation that the first pre-inspection task was performed;
obtain a result of the inspection of the building; and
schedule, at the first worker device, a follow-up task for the building, the follow-up task being automatically scheduled based on the result of the inspection of the building.

17. The system of claim 16, wherein the tradesman device schedules the follow-up task by:
determining a classification of the result of the inspection by classifying details of the result of the inspection using a classification model, the classification model comprising a neural network trained to automatically classify the details of the result.

18. The system of claim 16, further comprising:
a manager device configured to:
send the request for the inspection of the building to the tradesman device.

19. The system of claim 18, wherein the first worker device and the manager device have different views of data.

20. The system of claim 18, wherein the tradesman device is further configured to:
notify the manager device that the building is ready for the inspection in response to receiving the confirmation that the first pre-inspection task was performed.

21. The system of claim 16, further comprising:
a second worker device,
wherein the tradesman device is further configured to:
receive, from the first worker device, a request to reassign the first pre-inspection task to the second worker device; and
send, to the second worker device, the request to reassign the first pre-inspection task.

22. The system of claim 21, wherein the tradesman device is further configured to:
provide, to the first worker device, a list of crew members in a same location as the building.

23. The system of claim 16, wherein the tradesman device obtains the result of the inspection by calling an application programming interface (API) of an inspector management platform, and wherein the tradesman device is further configured to:
request inspection of the building from an inspector by calling the application programming interface (API) of the inspector management platform.

24. The system of claim 16, wherein the tradesman device is further configured to:
update inspection metrics based on the result of the inspection.

25. A server comprising:
a processor; and
a non-transitory computer readable medium storing instructions which, when executed by the processor, cause the processor to:
receive a request for an inspection of a building;
schedule a first pre-inspection task for the building in response to receiving the request for the inspection of the building;
receive a confirmation that the first pre-inspection task was performed;
obtain a result of the inspection of the building; and
schedule a follow-up task for the building, the follow-up task being automatically scheduled based on the result of the inspection of the building.

26. The server of claim 25, wherein scheduling the follow-up task for the building comprises:
determining a classification of the result of the inspection by classifying details of the result of the inspection using a classification model, the classification model comprising a neural network trained to automatically classify the details of the result.

27. The server of claim 25, wherein the instructions further cause the processor to:
schedule a second pre-inspection task for the building in response to receiving the request for the inspection of the building; and
cancel the second pre-inspection task in response to receiving the confirmation that the first pre-inspection task was performed.
